(19) United States
(12) Patent Application Publication
(10) Pub. No.: US 2006/0076502 A1
(43) Pub. Date: Apr. 13, 2006

(54) Method and apparatus for a photodetector responsive over a selectable wavelength range

(75) Inventors: Warren Timothy Boord, Brooklyn Park, MN (US); Anil Jain, North Oaks, MN (US)

Correspondence Address: MERCHANT & GOULD PC, P.O. BOX 2903, MINNEAPOLIS, MN, 55402-0903, US

(73) Assignee: APA Enterprises, Inc., Blaine, MN (US)

(21) Appl. No.: 11/244,247

(22) Filed: Oct. 5, 2005

Related U.S. Application Data
(60) Provisional application No. 60/616,453, filed on Oct. 5, 2004.

(51) Int. Cl. G01J 1/42

(52) U.S. Cl. 250/372

(57) ABSTRACT

Photodetectors are constructed with ternary semiconductor alloys, for which the band gap varies with composition, to fabricate a photodetector and optical filter combination. The detectors are part of a measuring system that measures, stores and displays UV intensity versus time, peak intensity, total UV energy and temperature. It simultaneously measures a plurality of different UV ranges and temperatures. The output of the sensing system is converted to digital form and displayed on a visually perceptible device. Preferably total UV dosage and peak intensity are displayed for each monitored UV band, together with the maximum temperature. By manufacturing the photodetectors and filters with a ternary semiconductor alloy, sensors can be constructed which have a photoresponse to light in a narrow wavelength band and are blind to light outside of the wavelength band. Each sensor includes a filter and photodetector section, each of which includes ternary semiconductor alloys (i.e., both the filter and photodetector are fabricated at least in part with ternary semiconductor alloys).

### FIELD OF THE INVENTION

This invention relates generally to photodetectors; and more particularly to a ternary semiconductor alloy photodetector for sensing light in a narrow wavelength band and to be blind to light outside the wavelength band.

### BACKGROUND

Photodetectors are utilized in a variety of environments. One environment is in manufacturing environments in which ultraviolet (UV) light curing stations are employed. In these environments, photodetectors are used to measure the wavelength and intensity of the UV source(s). Both on-line and batch devices are employed. On-line systems are generally used to continuously monitor the lights. These systems are mounted permanently for monitoring or looking at the UV source. The device is filtered to read the UV within a certain bandwidth of interest. Batch devices are used in modules which are run through the manufacturing facility to monitor the light which falls on the actual products being manufactured. These devices are also filtered to read the UV within a certain bandwidth of interest.

Previously, the photodetectors were constructed of Silicon and the devices accepted a wide range of UV light. In order for the devices to read only a certain bandwidth, several thin film filters were used to reject the visible and near infrared wavelength bands. Through use of these extra elements, the wavelengths not of interest were eliminated. However, the extra elements necessary to operate as a passband and band reject filter add expense to the detectors. Additionally, since there are four different ranges of UV light which are generally of interest in the manufacturing environment, the extra elements required for the filtering function need to be independently selected for each different UV range. This adds additional elements and complexity to the detector device. Also, the thin film filters degrade with long term exposure to UV radiation and humid air.

Therefore, there is a need in the art for a photodetector/filter system which requires fewer filtering elements, and which uses filtering techniques that are more stable in high intensity UV light environments. The present invention also overcomes other shortcomings of the prior art and addresses these needs in the art.

### SUMMARY

A preferred embodiment of an apparatus constructed according to the principles of the present invention includes photodetectors preferably constructed with ternary semiconductor alloys, for which the band gap varies with composition, to fabricate a photodetector and optical filter combination. The detectors are part of a measuring or sensing system that measures, stores and displays UV intensity versus time, peak intensity, total UV energy and temperature. It simultaneously measures a plurality of different UV ranges and temperatures. The output of the sensing system is converted to digital form and displayed on a visually perceptible device. Preferably total UV dosage and peak intensity are displayed for each monitored UV band, together with the maximum temperature.

By manufacturing the photodetectors and filters with a ternary semiconductor alloy, sensors can be constructed which have a photoresponse to light in a narrow wavelength band and are blind to light outside of the wavelength band. Each sensor includes a filter and photodetector section, each of which includes ternary semiconductor alloys (i.e., both the filter and photodetector are fabricated at least in part with ternary semiconductor alloys). More specifically, the construction preferably utilizes ternary semiconductor films on two transparent substrates. The substrate for the semiconductor film used as the photodetector need not be transparent. Both of the ternary semiconductor films (e.g., the filter and the photodetector) may be deposited on the same transparent substrate.

A plurality of sensors, wherein each discrete detector/filter combination is constructed to detect different wavelengths of UV light, are packaged and utilized in connection with monitoring a UV light environment. The plurality of sensor outputs is stored in a datalogger for subsequent review and analysis.

Therefore, according to one aspect of the present invention, there is provided an ultraviolet light sensor, comprising: a long pass filter; a photodetector, wherein the photo-response range of the photodetector is at or below a wavelength of interest; and wherein the first and second devices include AlGaN devices.

According to another aspect of the invention, there is provided a UV light sensing system, comprising: a housing; a plurality of UV photodetectors located in the housing, at least two of the UV photodetectors tuned to different UV wavelengths, the UV photodetectors having a photo-response range at or below a wavelength of interest and fabricated from a ternary semiconductor; and a plurality of corresponding long pass filters fabricated from a ternary semiconductor. Preferably the plurality of long pass filters and corresponding photodetectors have different band gaps adjusted by varying the composition of the ternary semiconductor. Further, preferably the ternary semiconductor is AlGaN or InGaN.

According to yet another aspect of the invention, there is provided a method of detecting ultraviolet light, comprising: directing ultraviolet light onto a transparent long pass filter constructed from Al_{y}Ga_{1-y}N, wherein when the ultraviolet light is incident on the filter, then light below a first wavelength is absorbed; directing the non-absorbed light onto a photodetector device constructed from AlₓGa₁₋ₓN, wherein the ultraviolet light below a second wavelength is absorbed and the photodetector generates electrical signals corresponding to the intensity of the absorbed light.

While the invention will be described with respect to preferred embodiment configurations and with respect to particular devices used therein, it will be understood that the invention is not to be construed as limited in any manner by either such configuration or components described herein. Also, while the particular types of ternary semiconductor alloys are described herein, it will be understood that such alloys are not to be construed in a limiting manner. Instead, the principles of this invention extend to any photodetector environment in which such alloys are used as a bandpass and band reject filter. Further, while the preferred embodiments of the invention will be generally described in relation to use in a UV manufacturing environment, it will be understood that the scope of the invention is not to be so limited. The invention may be employed in other environments in which UV sources are desired to be monitored. These and other variations of the invention will become apparent to those skilled in the art upon a more detailed description of the invention.

The advantages and features which characterize the invention are pointed out with particularity in the claims annexed hereto and forming a part hereof. For a better understanding of the invention, however, reference should be had to the drawings which form a part hereof and to the accompanying descriptive matter, in which there is illustrated and described a preferred embodiment of the invention.

### BRIEF DESCRIPTION OF THE DRAWINGS

Referring to the drawings, wherein like numerals represent like parts throughout the several views:

FIG. 1 is a schematic view of a UV light environment in which the present invention may be employed.

FIG. 2 is a schematic view of the functional blocks of the present invention.

FIG. 3 is a diagram of the light filtering steps of the present invention.

FIGS. 4a-4c is a series of diagrams illustrating the filtering of intensity versus wavelength that occurs in the light filtering steps of FIG. 3.

FIG. 5 is a representative schematic view of the shifting transmission wavelength that may be accomplished with varying the ternary semiconductor.

FIG. 6 is a schematic cross section view of a preferred embodiment package for an individual, discrete sensor constructed in accordance with the principles of the present invention.

FIG. 7a is a schematic layout of a preferred sensing system, including the electronics system, constructed in accordance with the principles of the present invention.

FIG. 7b is a functional block diagram of the electrical components utilized in the system.

FIG. 8 is a perspective view of the device of FIG. 7 having four photodetector window ports.

FIG. 9 is a schematic illustration of the construction of an individual sensor of FIG. 6a.

FIG. 10 is a graph illustrating the transmission versus wavelength of a multilayer dielectric thin film edge filter.

FIG. 11 is a graph illustrating transmission versus wavelength for a single crystal epitaxial film of Al_{0.07}Ga_{0.93}N on a sapphire substrate.

FIG. 12 is a graph illustrating transmission versus wavelength of a polycrystalline AlGaN film with many internal light scattering surfaces.

FIG. 13 is a graph illustrating photodetector current versus wavelength of a AlₓGa₁₋ₓN (where x approximately equals 0.17) detector and a Al_{y}Ga_{1-y}N (where y approximately equals 0.37) film filter.

### DETAILED DESCRIPTION

The principles of the present invention apply particularly well to its application in a UV curing environment. However, other environments in which a combined photodetector and optical filter is desired may also employ the principles of this invention. For example, the present invention may be employed in other applications in which UV lighting should be monitored and/or regulated. Specific examples include monitoring ultra violet lamps in ink and paint curing systems with discrete detectors tuned to a different portion of the UV spectrum. To better describe the invention, a detailed description will be deferred pending a brief overview of a preferred environment in which the present invention is employed.

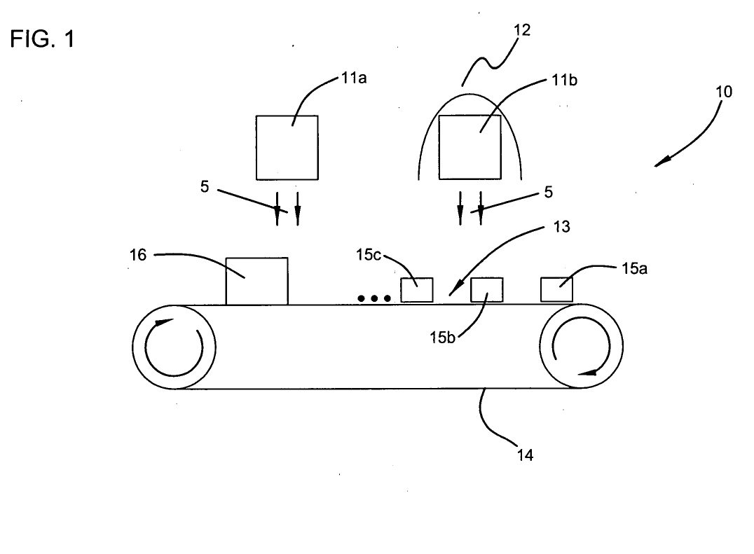

Referring first to FIG. 1, there is shown a schematic view of a UV light environment 10 in which the present invention may be employed. In the representative environment, two UV lights 11a and 11b are shown. The UV lights 11a and 11b may be used with or without a mirror 12. It will be appreciated that the style and number of light sources, as well as the other physical components such as shades, reflectors, lenses, etc. may be varied in accordance with the UV light environment. Accordingly, the environment 10 is representative and not limiting. The UV light is directed onto a light receiving station 13 as indicated by the downward directional arrows designated as 5 in FIG. 1. The light receiving station 13 includes an endless, moving conveyor belt 14 in FIG. 1. However, the light receiving station 13 may be stationary, may be comprised of a series of rollers, and/or may be batch loaded, among other options. The articles 15a-15c to receive the UV light for curing are transported or placed on the belt 14, and then move to and through the light receiving station 13. While only three articles 15a-15c are shown moving through the light receiving station 13, it will be appreciated that such articles are representative and that the number shown in FIG. 1 is not limiting.

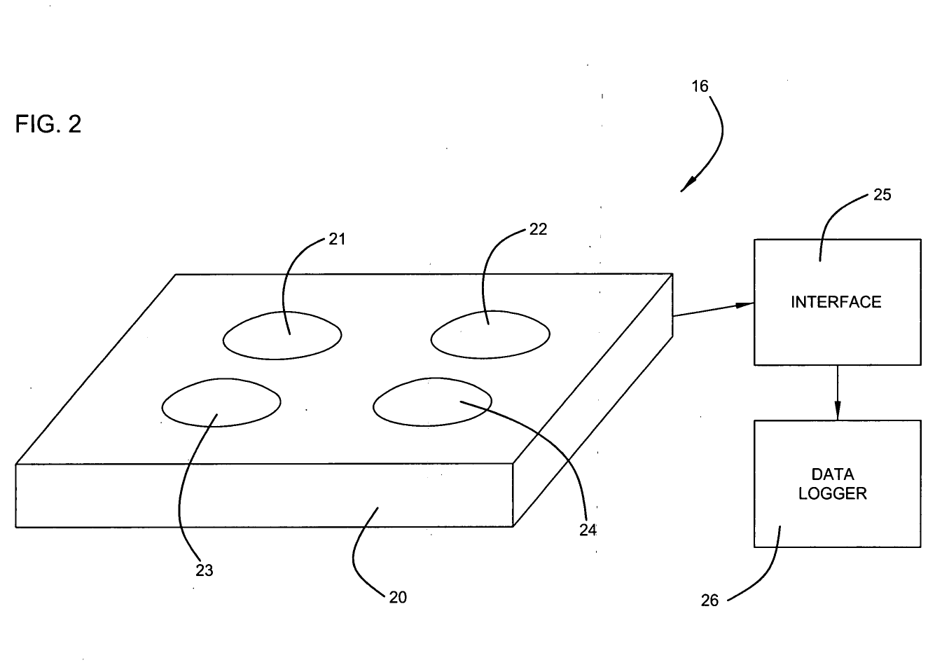

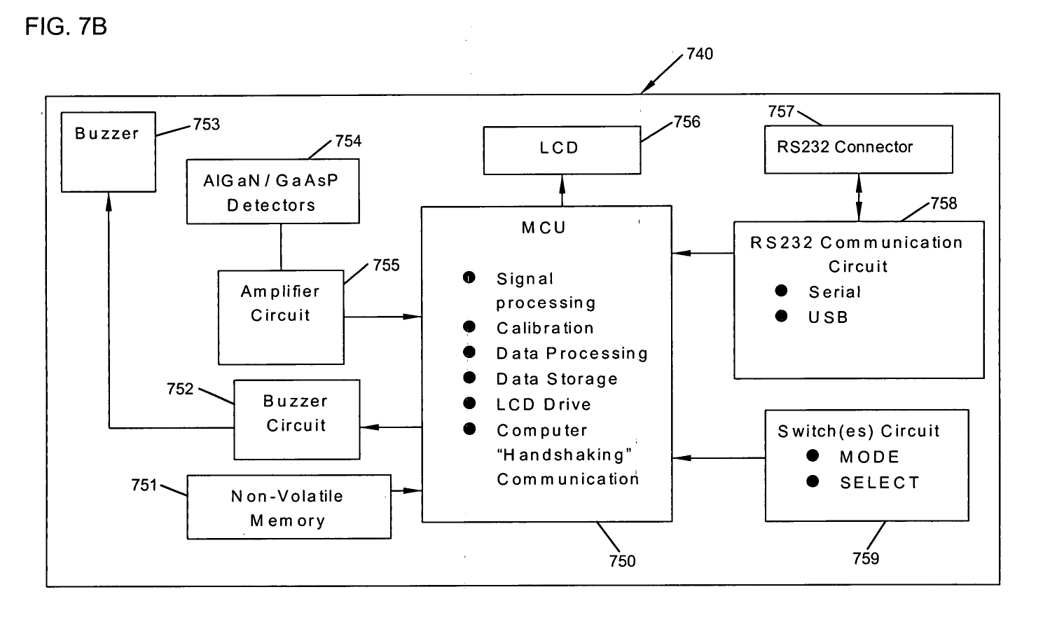

In order to maintain quality, it is often desirable to determine the amount of light that falls on the articles 15a-15c and the wavelength of that light. Sensing system 16 is illustrated as being placed on the belt 14 in order to travel through the light receiving station 13. FIG. 2 schematically illustrates several of the main functional elements of the sensing system 16. These elements include a housing 20, four discrete sensors 21-24, an interface 25, and a data logger 26. Other functional components of the sensing system 16 including the control electronics, data storage memory, LCD, etc. are shown functionally in FIGS. 7a and 7b (described more fully below).

Generally, the discrete sensors 21-24 are utilized to detect different wavelengths of the UV band (e.g., of the light emitted by light sources 11a and 11b). Accordingly, while the four discrete sensors 21-24 are preferably constructed to detect UVV, UVA, UVB and UVC wavelengths, any other numbers of discrete detectors may be employed based on the number of wavelengths of interest.

As the discrete sensors 21-24 move into and through the light receiving station 13, the collected information from the discrete sensors 21-24 is transmitted to the interface 25 and stored in the data logger 26. In this manner, the intensity and wavelength of the UV light sources 11a and 11b can be monitored and adjusted as necessary.

Turning now to a more detailed discussion on the discrete sensors 21-24 and the sensing system 16, the present invention preferably includes ternary semiconductor alloys for each discrete sensor 21-24 wherein the band gap varies with composition. The resulting sensor is therefore a combined photodetector and optical filter combination that senses light in a narrow wavelength band and is blind to light outside of the wavelength band. A semiconductor alloy composition with a bandgap E1 is used to define a long wavelength pass filter for which the optical transmission T is:
T=0 for λ<λ₁; and (1)
T>0 for λ>λ₁ (2)
A second semiconductor alloy composition with a bandgap E2 (where E2<E1) is used to fabricate a photodetector which senses light of wavelength λ<λ₂, where λ₂>λ₁.

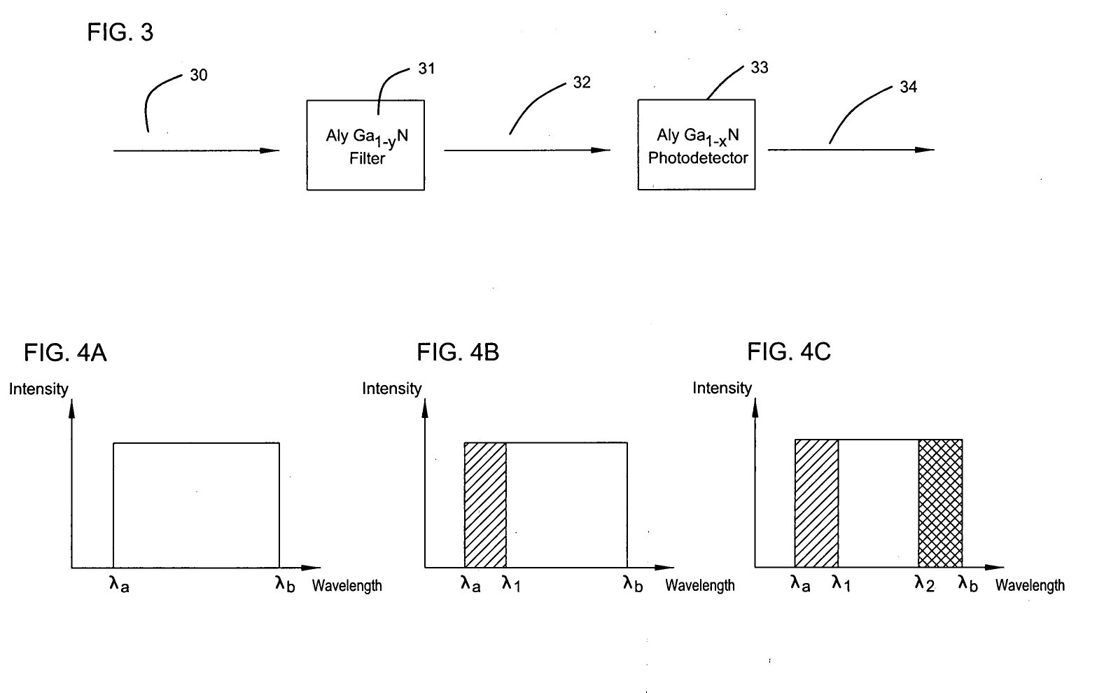

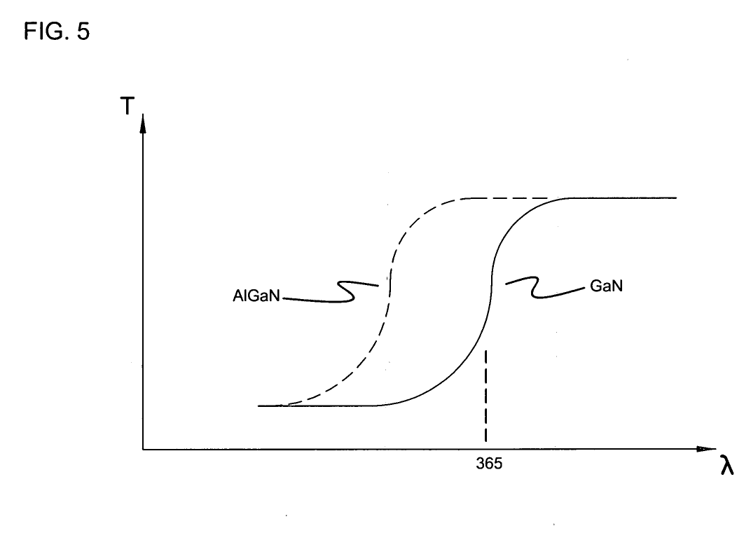

The detector and filter combination senses light only in the wavelength band λ=λ₁ to λ₂. The width of the wavelength band, Δλ=λ₂−λ₁, and the location of the band, λ₁ to λ₂, can be adjusted by changing the semiconductor alloy composition of the optical filter and of the photodetector. The concept is illustrated in FIGS. 3 and 4a-4c using the ternary semiconductor AlₓGa₁₋ₓN as an example. This material can be used to fabricate photodetectors and optical filters for wavelengths 200 nm<λ<365 nm. An InₓGa₁₋ₓN ternary semiconductor can be used to fabricate photodetectors and optical filters for 365 nm<λ<635 nm (or a GaAsP detector can optionally be used together with an absorption filter). An AlₓGa₁₋ₓAs ternary semiconductor can be used to fabricate photodetectors and optical filters for 575 nm<λ<870 nm.

In FIGS. 3 and 4a-4c, light 30 is incident on Al_{y}Ga_{1-y}N filter block 31. The light 30 is comprised of wavelengths λₐ through λ_{b} as shown in FIG. 4a. Filter block 31 absorbs the light in the wavelength λₐ through λ_{b} as shown in FIG. 4b. The resulting light 32 is incident on AlₓGa₁₋ₓN photodetector block 33. Here the light absorbed is between the wavelengths λ₁ to λ₂—which in this example is the light of interest. The light 34 is light in the wavelength λ₂ to λ_{b}. In this manner, a ternary semiconductor Al_{z}Ga_{1-z}N is used to define a photodetector-filter assembly that senses light only in the wavelength band defined by the bandgaps of Al_{y}Ga_{1-y}N and AlₓGa₁₋ₓN.

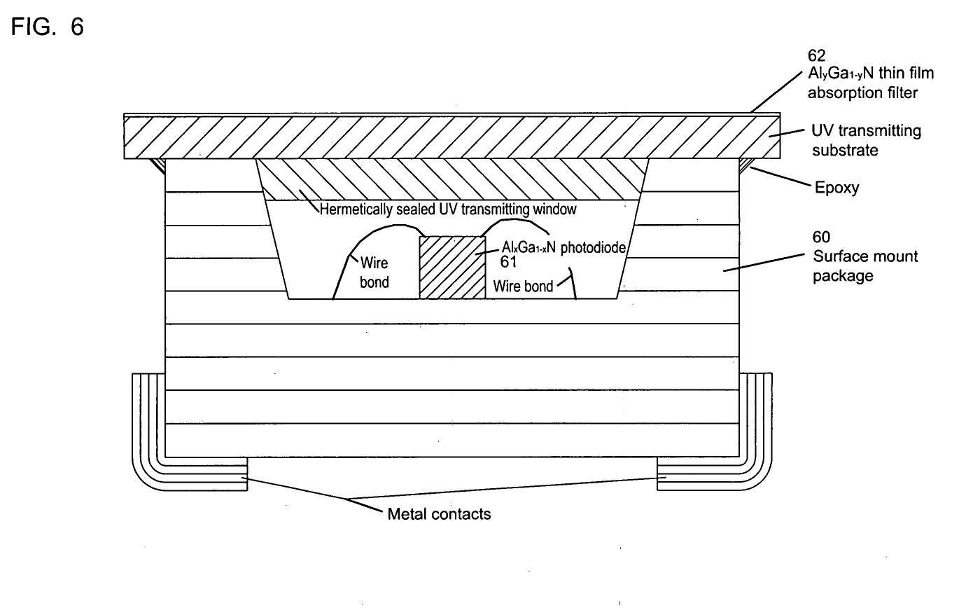

In FIG. 5, the general concept of shifting the transmission about a representative wavelength in a GaN detector by adding aluminum is illustrated.

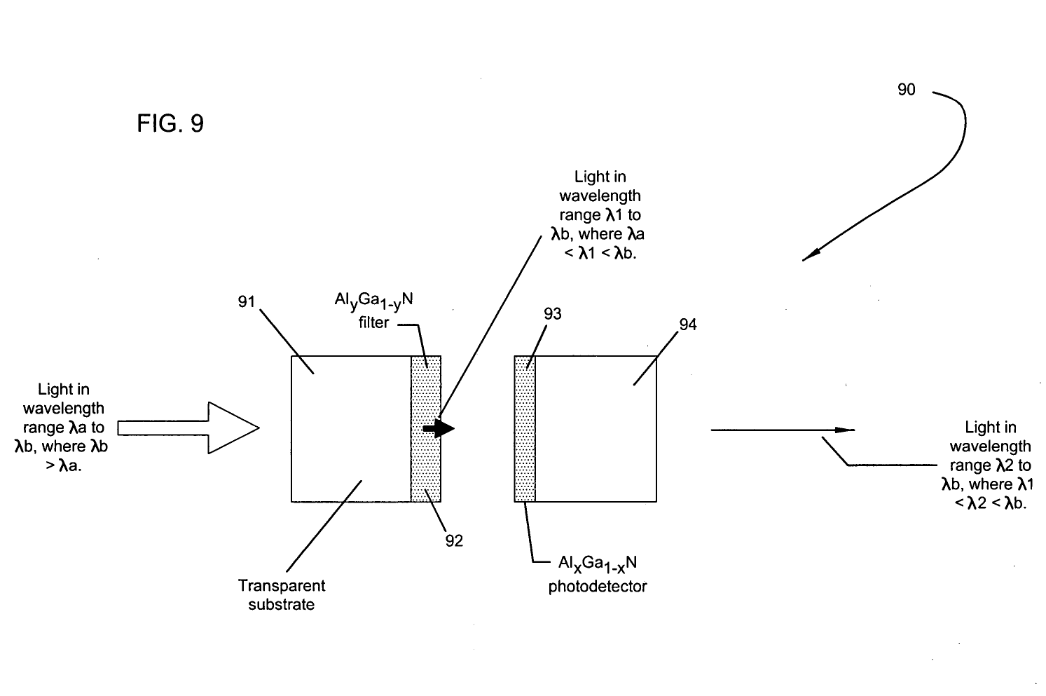

In a preferred embodiment, each of the discrete sensors 21-24 may be constructed as generally shown in FIG. 9 at designation 90. Here, the construction preferably utilizes films of the ternary semiconductor system on two transparent substrates 91 and 94. However, the substrate 94 for the semiconductor film 93 used as the photodetector need not be transparent. Both of the ternary semiconductor films (e.g., the filter 92 and the photodetector 93) may be deposited on the same transparent substrate 91. The semiconductor films 92 and 93 of FIG. 9 perform the functions of blocks 31 and 33 in FIG. 3.

The following Table I illustrates the UV band of interest together with example filter and photodetector compositions.

TABLE I

| | Wavelength | | Photodetector |
|---|---|---|---|
| UV Band | Range, nm | Short λ Filter | Active Medium |
| UVV | 395 to 445 | In_{0.11}Ga_{0.88}N | In_{0.28}Ga_{0.72}N |
| UVA | 320 to 390 | Al_{0.17}Ga_{0.83}N | In_{0.09}Ga_{0.91}N |
| UVB | 280 to 320 | Al_{0.37}Ga_{0.63}N | Al_{0.17}Ga_{0.83}N |
| UVC | 250 to 260 | Al_{0.56}Ga_{0.44}N | Al_{0.49}Ga_{0.51}N |
| | | (short wavelength filter | |
| | | may not be needed) | |

Experimental results indicate that a 1 micron thick Al_{0.37}Ga_{0.63}N short wavelength filter reduced the photodetector responsivity by 3 orders of magnitude.

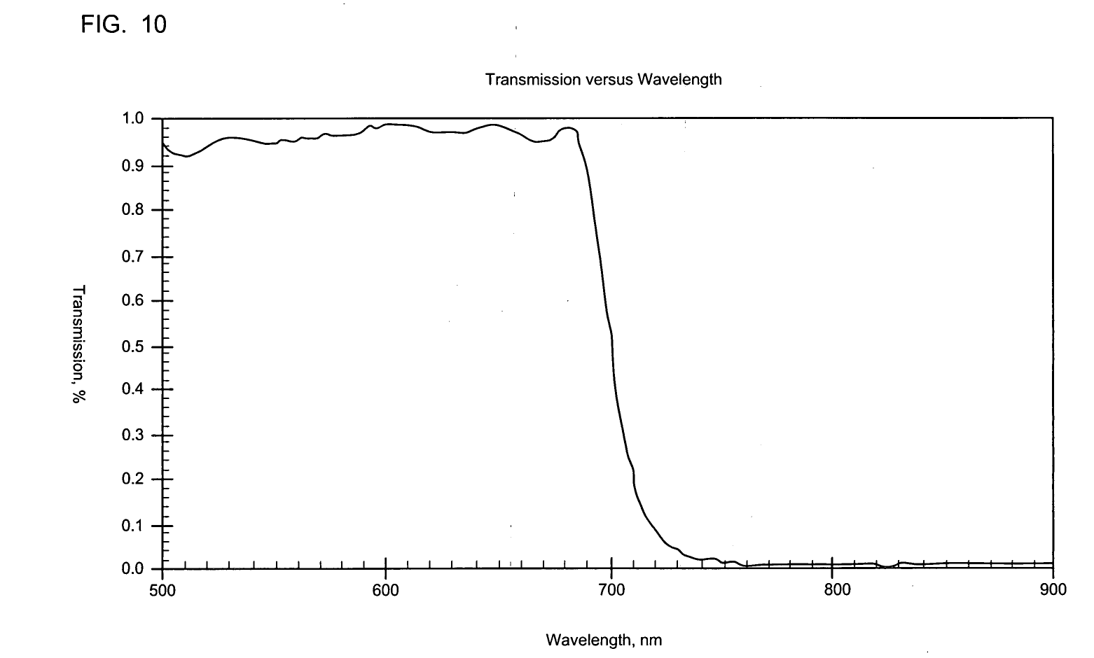

Multilayer film structures of dielectric materials could also be used to fabricate a long pass edge filter that would serve the same function as the Al_{y}Ga_{1-y}N filter film in FIG. 9. However, the transmission in the pass band of the multilayer edge filter typically varies with wavelength, as shown in FIG. 10. Also, the spectral variation of the passband transmission and the wavelength location of the passband edge change with angle of incidence of the input light beam. This wavelength and angle of incidence sensitivity of the transmission limits the accuracy achievable when the incident light spectral content and propagation properties are not controlled. The transmission of a high quality Al_{y}Ga_{1-y}N film filter also varies with the wavelength and the light incidence angle.

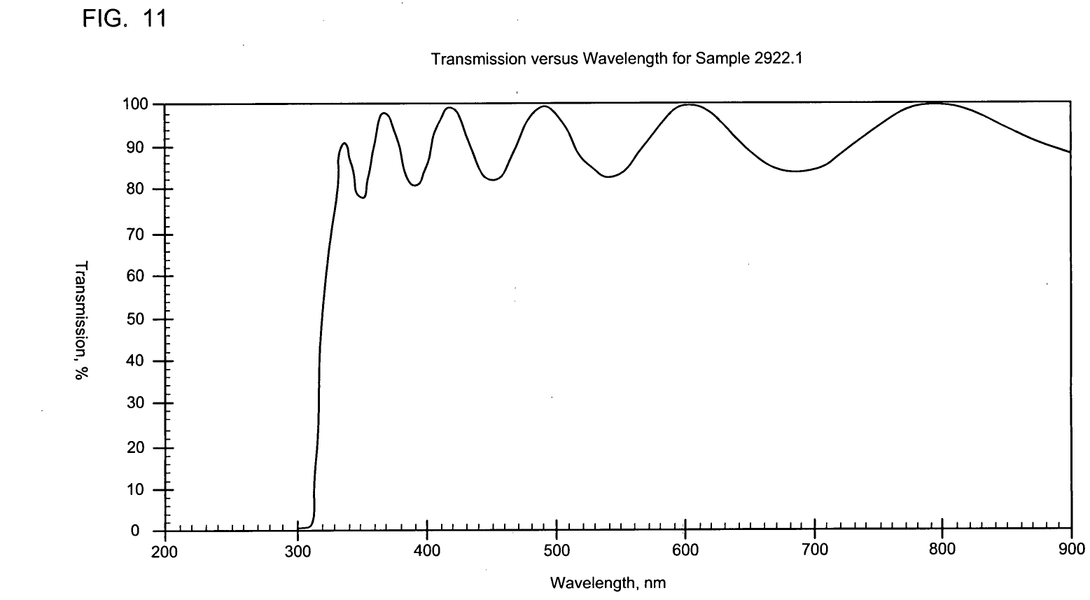

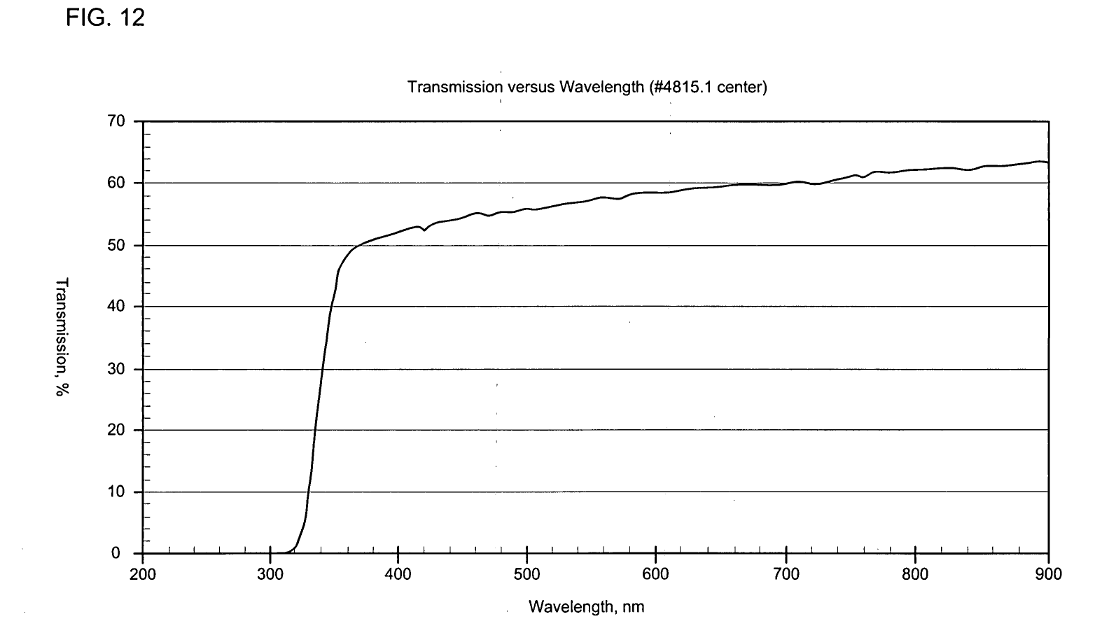

A second feature of the present invention involves modifying the structural properties of the Al_{y}Ga_{1-y}N film filter to eliminate the wavelength dependency of the Al_{y}Ga_{1-y}N film filter transmission. FIG. 11 illustrates the transmission versus wavelength for a single crystal epitaxial film of Al_{0.07}Ga_{0.93}N on a sapphire substrate. The variation in transmission with wavelength for λ>340 nm is a result of the interference of light reflected at the Al_{0.07}Ga_{0.93}N to air interface with light reflected at the Al_{0.07}Ga_{0.93}N to sapphire substrate interface. If the deposition conditions for the Al_{0.07}Ga_{0.93}N film are adjusted so that a polycrystalline film with many internal light scattering surfaces is deposited, then the interference between light reflected from the front and back surfaces of the Al_{0.07}Ga_{0.93}N film is reduced and a transmission band without the interference fringes results. The transmission of such a scattering film is shown in FIG. 12. By eliminating the interference fringes in the passband region, the stability of the photodetector/filter combination is improved when operating under conditions of varying angle of incidence and light wavelength.

As will be appreciated by those skilled in the art, an aspect of the use of two films of different ternary semiconductor compositions to define the short and long wavelengths edges of the optical passband is the adjustment of the short wavelength filter film deposition conditions to create a polycrystalline film with many internal UV light scattering surfaces. This scattering film smoothes out the transmission versus wavelength characteristics of the film at wavelengths beyond the absorption edge. Thus, with the scattering film, there are no interference fringes in the passband. By eliminating the interference fringes, variations of the detected light signal with change in the light angle of incidence is eliminated, and therefore a more accurate measurement of the UV lamp intensity versus position under the lamp is obtained.

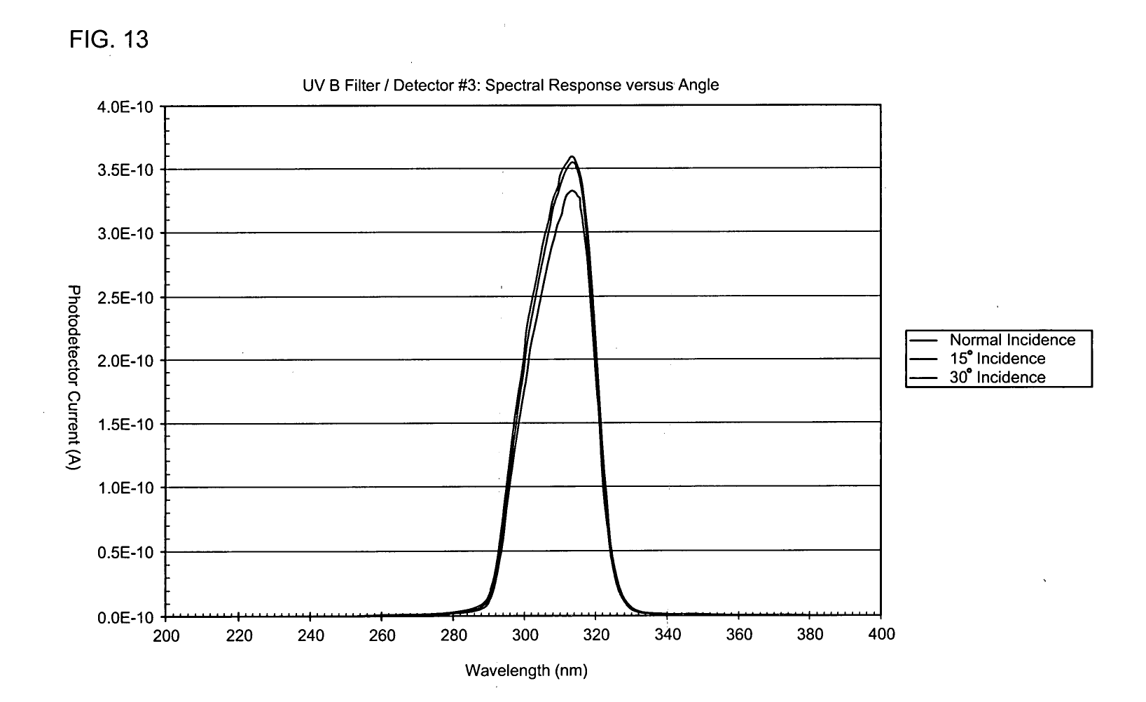

FIG. 13 shows the photoresponse versus wavelength of an AlₓGa₁₋ₓN (x ≅0.17) photodetector and an Al_{y}Ga_{1-y}N (y≅0.37) film filter. The long wavelength edge of the photoresponse band is defined by the AlₓGa₁₋ₓN photodetector, and the short wavelength edge of the photoresponse band is defined by the Al_{y}Ga_{1-y}N filter. This photodetector-filter system can be used to monitor the UVB spectral region of the ultraviolet spectrum. By way of example, the intensity of ultra violet lamps used in ink and paint curing systems could be monitored with a set of such photodetector-filter systems (each tuned to a different portion of the UV spectrum) to control the UV curing process.

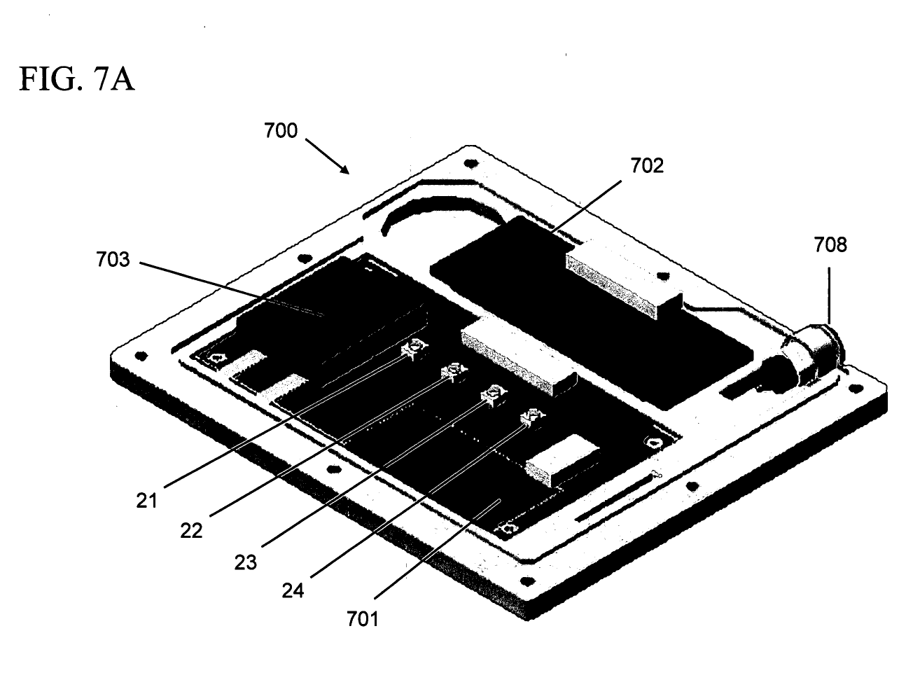

Turning now to FIG. 6, a preferred embodiment of discrete sensors 21-24 is illustrated. A surface mount package 60 is illustrated with AlGaN photodetector device chip 61 located therein. AlGaN filter chip 62 is located on the top surface of the surface mount package 60.

FIG. 7a functionally illustrates a preferred embodiment sensing system 700, including the supporting electronics. Printed circuit board 701 incorporates the microprocessor control unit, the photodetectors (21, 22, 23 & 24) and amplifiers, non-volatile memory, RS232 communication circuit, a rechargeable battery 703, and buzzer alarm electronics. The non-volatile memory is provided to store the collected sensor 21-24 readings. A visually perceptible interface 702 is provided for displaying data. In the preferred embodiment, the interface 702 is an LCD. An interface 708 to transfer the data from memory to a computer (not shown) for analysis is also provided. Batteries 703 preferably power the electronics of the device.

FIG. 7b is a functional block diagram of the electrical components utilized in the system. The schematic is shown generally in FIG. 7b at 740. The central processor block 750 provides for signal processing of the signals generated by the sensor block 754 (e.g., A/D conversion of the incoming signals, as well as other necessary signal processing), calibration of the system, data processing, data storage, LCD drive and computer “handshaking” communication. In the preferred embodiment, a model PIC18F452-I/PT type chip manufactured by Microchip of Chandler, Ariz. is utilized. However, other devices that can provide these functions might also be used, including microcontrollers and other PC style chips. The detector block 754 includes the individual sensors 21-24. The output signals from the individual sensors are provided to the amplifier circuit block 755. Generally the amplifier circuit block 755 includes op amps and converts the currents generated by the sensors of the detector block 754 into an analog output signal provided to the central processor block 750. In the preferred embodiment, the amplifier circuit block is a chip manufactured by National Semiconductor of Santa Clara, Calif. having the designation LMC6044AIM. However, other devices may be used to perform these functions. The analog signal from amplifier circuit block 755 is digitized by the A/D converter systems/routines of central processor block 750. The digitized data is then stored for subsequent downloading.

Buzzer block 753 is connected to the buzzer circuit block 752. Buzzer block 753 sounds an alarm if the unit overheats and/or is otherwise overloaded with data. The buzzer may also be utilized in connection with confirming the activation of the switches on switch block 759. Other perceptible indicia devices (e.g., lights and other signals) may be also be utilized, rather than a buzzer. Non-volatile memory block 751 provides memory for programming, routines, and other memory functions for the central processor block 750. In the preferred embodiment, the non-volatile memory may be implemented with a chip manufactured by Microchip of Chandler, Ariz., under the designation 24LC128-I/SN. However, other memory elements (e.g., memory sticks and other recordable mediums and chips) might also be used. LCD block 756 provides a visually perceptible readout of the status, functions, and data of the system. In the preferred embodiment the display is manufactured by Varitronix Limited, of Hong Kong. The display model number is MDLS-16263-C-LV-G. Other types of displays might also be used (e.g., LED devices, etc.).

Input switches are provided at switch circuit block 759. Switches are provided to power the unit on and off as well as to select the various modes of the system 740. For example, a mode may be selected to record the maximum power and integrate to determine the total energy received by detector block 754. Another mode may include a profile mode that records the power received by the detector block 754 versus time.

The RS232 communications block 758 can provide either serial or USB communications for the system 740. Such communications can include downloading of data, programming the system 740 from a PC or other computer, field upgrading system 740, running diagnostics, etc. RS232 connector block 757 is connected to the RS232 block 758 in order to physically connect the system 740 to computers for downloading, analyzing, storing the data recorded by system 740. It will be appreciated that communication devices may be utilized (e.g., RF and IR systems).

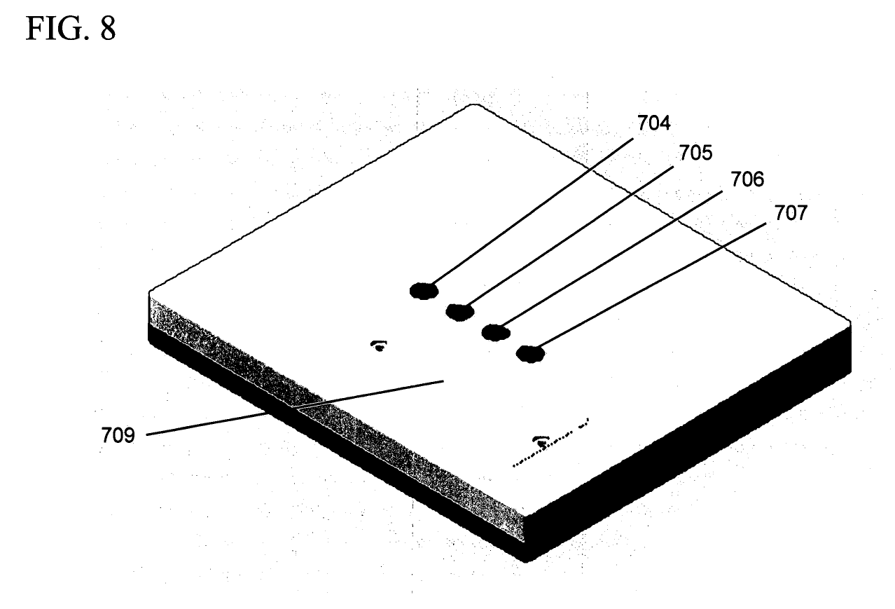

FIG. 8 illustrates a backside of the sensing system 700 of FIG. 7a. Window assemblies 704-707 are provided for sensors 21-24. Cover plate 709 provides access to electrical connectors for loading program files into the microprocessor and to adjustable resistors used to tune the photodetector amplifier gain. While those of skill in the art will appreciate how to construct a detector for UV light in view of the description herein, reference may also be had to U.S. Pat. No. 6,104,074 (which is incorporated herein by reference).

It will be appreciated that the principles of this invention apply not only to detecting UV light, but also to the method of collecting and displaying the information. While particular embodiments of the invention have been described with respect to its application, it will be understood by those skilled in the art that the invention is not limited by such application or embodiment or the particular components disclosed and described herein. It will be appreciated by those skilled in the art that other components that embody the principles of this invention and other applications therefor other than as described herein can be configured within the spirit and intent of this invention. The arrangement described herein is provided as only one example of an embodiment that incorporates and practices the principles of this invention. Other modifications and alterations are well within the knowledge of those skilled in the art and are to be included within the broad scope of the appended claims.

What is claimed is:

1. An ultraviolet light sensor, comprising:
a. a long pass filter;
b. a photodetector, wherein the photo-response range of the photodetector is at or below a wavelength of interest; and
c. wherein the first and second devices include AlGaN devices.

2. The sensor of claim 1, wherein the long pass filter and the photodetector have different band gaps adjusted by varying the Al and Ga concentrations in the ternary semiconductor AlₓGa₁₋ₓN.

3. The sensor of claim 2, wherein Al is replaced with In.

4. The sensor of claim 3, further comprising a sapphire base to support the photodetector.

5. The sensor of claim 4, wherein a first side of the photodetector is placed directly on the sapphire base.

6. The sensor of claim 5, wherein the long pass filter is placed on the second side of the photodetector.

7. The sensor of claim 6, wherein the long pass filter is placed directly on the second side of the photodetector and the ternary semiconductor film filter includes a polycrystalline film with many internal light scattering surfaces.

8. The sensor of claim 6, wherein the long pass filter is on a transparent substrate and the ternary semiconductor film filter includes a polycrystalline film with many internal light scattering surfaces.

9. The sensor of claim 1, wherein the photodetector generates UV intensity signals comprised of electrical signals in response to incident UV light.

10. The sensor of claim 9, further comprising a data logger for storing the UV intensity signals and wherein the generated electrical signals are proportional to the incident UV light intensity.

11. A UV light sensing system, comprising:
a) a housing;
b) a plurality of UV photodetectors located in the housing, at least two of the UV photodetectors tuned to different UV wavelengths, the UV photodetectors having a photo-response range at or below a wavelength of interest and fabricated from a ternary semiconductor; and
c) a plurality of corresponding long pass filters fabricated from a ternary semiconductor.

12. The sensing system of claim 11, wherein the plurality of long pass filters and corresponding photodetectors have different band gaps adjusted by varying the composition of the ternary semiconductor.

13. The sensing system of claim 12, wherein the ternary semiconductor is AlGaN or InGaN.

14. The sensing system of claim 13, wherein each of the plurality of photodetectors generate UV intensity signals based on the detected UV light.

15. The sensing system of claim 14, further comprising a data logger for storing the UV intensity signals.

16. A method of detecting ultraviolet light, comprising:
a. directing ultraviolet light onto a transparent long pass filter constructed from Al_{y}Ga_{1-y}N, wherein when the ultraviolet light is incident on the filter, then light below a first wavelength is absorbed;
b. directing the non-absorbed light onto a photodetector device constructed from AlₓGa₁₋ₓN, wherein the ultraviolet light below a second wavelength is absorbed and the photodetector generates electrical signals corresponding to the intensity of the absorbed light.

17. The method of claim 16, further comprising adjusting the band gaps of the long pass filter and the photodetector by adjusting the Al and Ga concentrations of the AlGaN.

18. The method of claim 17, wherein the ternary semiconductor is InGaN.

19. The method of claim 18, further comprising storing the generated signals.
